(19) United States
(12) Patent Application Publication
(10) Pub. No.: US 2014/0108560 A1
(43) Pub. Date: Apr. 17, 2014

(54) DYNAMIC ROUTING OF A COMMUNICATION BASED ON CONTEXTUAL RECIPIENT AVAILABILITY

(71) Applicant: DISNEY ENTERPRISES, INC., Burbank, CA (US)

(72) Inventors: Amber Samdahl, La Canada Flintridge, CA (US); Jeffrey Voris, Pasadena, CA (US)

(21) Appl. No.: 13/650,993

(22) Filed: Oct. 12, 2012

(51) Int. Cl. H04L 12/58

(52) U.S. Cl. CPC H04L 51/00
USPC 709/206

(57) ABSTRACT

A plurality of potential recipients of a communication is monitored according to one or more monitored contextual characteristics. Further, a score is calculated for each of the plurality of potential recipients based upon the one or more monitored contextual characteristics. In addition, one or more recipients of the communication are selected from the plurality of potential recipients of the communication based upon the score for each of the plurality of potential recipients.

### BACKGROUND

1. Field

This disclosure generally relates to the field of computer systems. More particularly, the disclosure relates to communication between computer systems.

2. General Background

Some current communication systems ensure that a communication from a sender is sent to a particular recipient. For example, a sender may send an e-mail, text message, voice mail, etc. to a particular recipient. The particular recipient receives the communication, but may not be available to read or listen to the communication at the particular time that is desired by the sender, e.g., a time-sensitive communication that necessitates feedback from the recipient to the sender within a particular time period. Examples of such time-sensitive communications include emergency response communications, logistical communications for placement of products and/or services in a business environment, commercial transaction communications, delivery service communications, or the like. In such instances, recipient unavailability within the particular time period may adversely affect the ability of the sender to perform certain functions. It is believed that improvements in conventional communication systems are needed to better support time-sensitive communication environments.

### SUMMARY

In one aspect of the disclosure, a computer program product is described. The computer program product includes a computer readable medium having a computer readable program stored thereon. The computer readable program while executing on a computer causes the computer to monitor a plurality of potential recipients of a communication according to one or more monitored contextual characteristics. Further, the computer readable program while executing on the computer causes the computer to calculate a score for each of the plurality of potential recipients based upon the one or more monitored contextual characteristics. In addition, the computer readable program while executing on the computer causes the computer to select one or more recipients of the communication from the plurality of potential recipients of the communication based upon the score for each of the plurality of potential recipients.

In another aspect of the disclosure, a process is described. The process monitors a plurality of potential recipients of a communication according to one or more monitored contextual characteristics. Further, the process calculates, with a processor, a score for each of the plurality of potential recipients based upon the one or more monitored contextual characteristics. In addition, the process selects one or more recipients of the communication from the plurality of potential recipients of the communication based upon the score for each of the plurality of potential recipients.

In yet another aspect of the disclosure, a system is described. The system comprises a processor configured to monitor a plurality of potential recipients of a communication according to one or more monitored contextual characteristics. Further, the processor is configured to calculate a score for each of the plurality of potential recipients based upon the one or more monitored contextual characteristics. In addition, the processor is configured to select one or more recipients of the communication from the plurality of potential recipients of the communication based upon the score for each of the plurality of potential recipients.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates a communication configuration that is utilized to select one or more recipients for a communication.

FIG. 2 illustrates the communication configuration illustrated in FIG. 1 having a selection of recipients from the plurality of potential recipients.

FIG. 3 illustrates a contextual availability configuration.

FIG. 4 illustrates the components of the contextual availability routing system illustrated in FIG. 3.

FIG. 5 illustrates a process that is utilized to provide contextual routing availability.

### DETAILED DESCRIPTION

A computer program product, method, and system are utilized to provide recipient contextual availability to a sender of a communication. The sender determines a plurality of potential recipients for the communication. In other words, the sender is not limited to sending the communication to a particular recipient. The sender determines a plurality of potential recipients such that the sender is fine with any the plurality of receiving the communication. That plurality of potential recipients is monitored according to various contextual characteristics. Further, one or more potential recipients that most ideally meet such contextual characteristics are selected to receive the communication.

The contextual characteristics are characteristics indicative of a particular context pertaining to each potential recipient of the communication. Examples of contextual characteristics include, but are not limited to, recipient availability, willingness, available communication modes, past recipient behavior, future recipient plans, or the like. For instance, a communication device of a potential recipient may indicate that the potential recipient is stationary, the potential recipient is not on a phone call, and the communication device is on ring. Such monitored contextual characteristics indicate that the potential recipient is likely available and willing to receive a communication.

The communication is a message between the sender and the recipient that is facilitated through a communication device, e.g., a computing device, telephone, smartphone, or the like. For example, the message may be an e-mail, text message, telephone call, voice mail, video conference, chat message, or the like. A computing device may be a personal computer (“PC”), laptop, smartphone, tablet device, set top box, or the like.

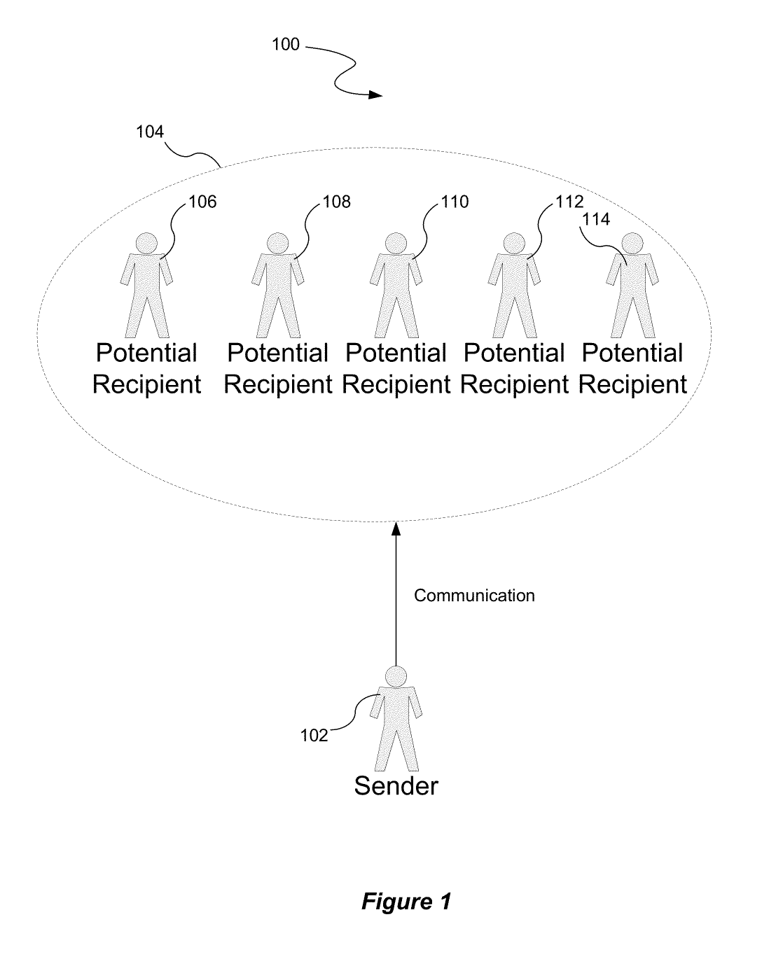

FIG. 1 illustrates a communication configuration 100 that is utilized to select one or more recipients for a communication. The communication configuration 100 includes a sender 102 that intends on sending a communication. The communication configuration 100 also includes a plurality of potential recipients 104. As an example, the plurality of potential recipients 104 includes a potential recipient 106, a potential receipting 108, a potential recipient 110, a potential recipient 112, and a potential recipient 114. In one aspect, the plurality of potential recipients 104 is manually inputted by the sender 102. In other words, the sender 102 inputs the potential recipients through a graphical user interface (“GUI”) in a list format. In an alternative aspect, the plurality of potential recipients 104 is automatically determined based upon sender data. The plurality of potential recipients 104 is automatically determined from a list of social networking friends, a list of contacts, or the like.

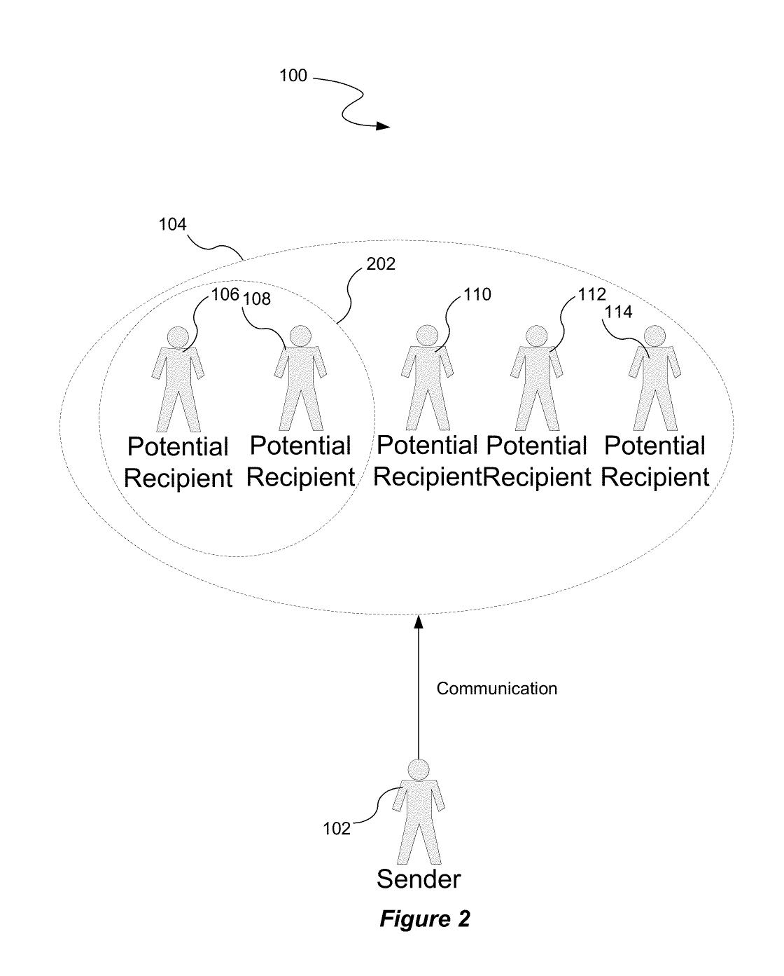

FIG. 2 illustrates the communication configuration 100 illustrated in FIG. 1 having a selection of recipients from the plurality of potential recipients 104. Based on various monitored contextual characteristics, a plurality of recipients 202 is selected to receive the communication. The contextual characteristics of each of the potential recipients in the plurality of potential recipients 104 are monitored. A scoring methodology is then utilized to determine a score for each of the potential recipients in the plurality of potential recipients 104. The scores are then ranked to determine which of the potential recipients are selected to receive the communication. As an example, the potential recipients may have been ranked from the highest to lowest scores as follows: the potential recipient 106, the potential recipient 108, the potential recipient 110, the potential recipient 112, and the potential recipient 114. As the potential recipient 106 and the potential recipient 108 had the highest scores, those potential recipients are selected as the plurality of recipients 202 to receive the communication.

In one aspect, a predetermined quantity of highest scores is utilized to determine the quantity of potential recipients that is selected to receive the communication. As an example, the predetermined quantity may be two. In another aspect, a predetermined score threshold is utilized to determine the quantity of potential recipients that is selected to receive the communication. Any potential recipient with a score that surpasses the threshold is selected to receive the communication.

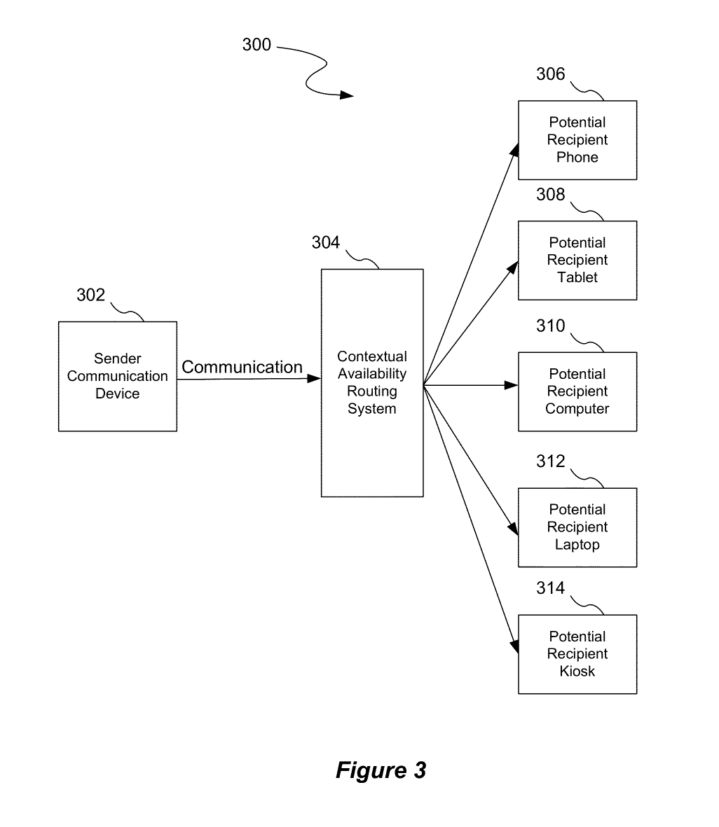

FIG. 3 illustrates a contextual availability configuration 300. The contextual availability configuration 300 includes a sender communication device 302 that sends a communication to a contextual availability routing system 304. In other words, the sender 102 illustrated in FIGS. 1 and 2 does not have to be concerned with sending the communication to any particular recipient. The sender 102 sends the communication to the contextual availability routing system 304, which monitors the plurality of potential recipients 104 of the communication according to one or more monitored contextual characteristics. The contextual availability routing system 304 also calculate a score for each of the plurality of potential recipients based upon the one or more monitored contextual characteristics. Further, the contextual availability routing system 304 selects one or more recipients of the communication from the plurality of potential recipients of the communication based upon the score for each of the plurality of potential recipients. In one aspect, the contextual availability routing system 304 sends the communication to a communication device utilized by a recipient. Examples of possible communication devices that may be utilized by the recipients are as follows: a potential recipient phone 306 utilized by the potential recipient 106, a potential recipient tablet 308 utilized by the potential recipient 108, a potential recipient computer 310 utilized by the potential recipient 110, a potential recipient laptop 312 utilized by the potential recipient 112, and a potential recipient kiosk 314 utilized by the potential recipient 114. In one aspect, the type of communication device utilized by a potential recipient is a monitored contextual characteristic that affects the score of a potential recipient, e.g., a contextual characteristic of a computer such as a PC has a higher score than a contextual characteristic of a laptop since the computer is generally more stationary, which suggests more likely availability to receive the communication.

In another aspect, the contextual availability routing system 304, performs the monitoring, score calculation, and recipient selection without sending the communication to the recipients. The contextual availability routing system 304 sends a message to the sender communication device 302 indicating to which recipients the communication should be sent by the sender communication device 302. Alternatively, the contextual availability routing system 304 sends the communication to another communication device to send to the selected recipients. Accordingly, the contextual availability routing system 304 may or may not have its own communication components to send the communication to the communication devices of the selected recipients.

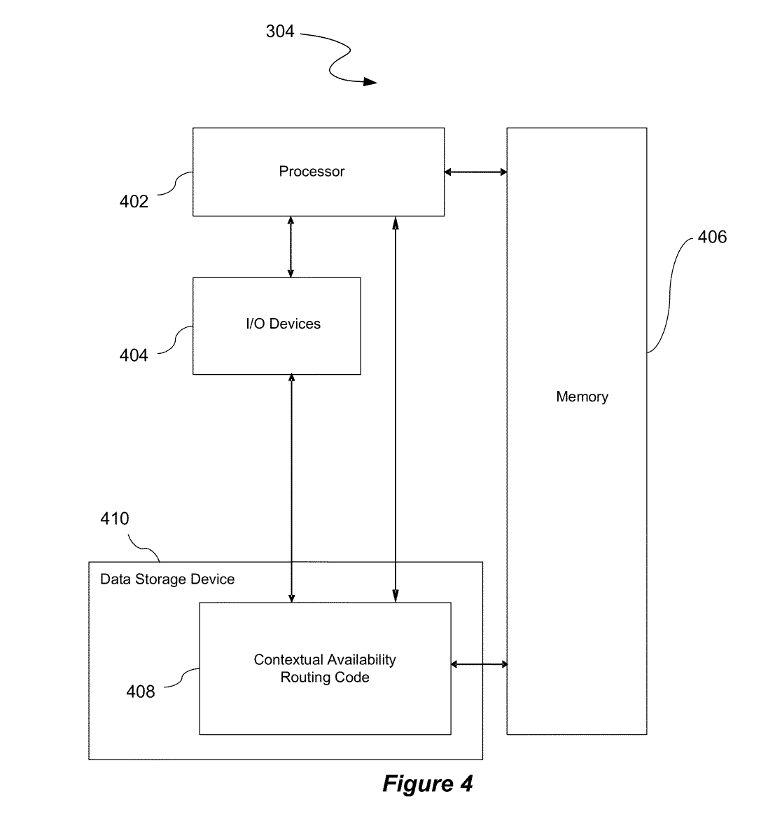

FIG. 4 illustrates the components of the contextual availability routing system 304 illustrated in FIG. 3. In one aspect, the contextual availability routing system 304 is implemented utilizing a general purpose computer or any other hardware equivalents. As illustrated, the contextual availability routing system 304 comprises a processor 402, a memory 406, e.g., random access memory (“RAM”) and/or read only memory (ROM), a set of contextual availability routing code that provides instructions for monitoring, score calculation, and selection, a data storage device 410 that stores the set of contextual availability routing code 408, and various input/output devices 404, (e.g., audio/video outputs and audio/video inputs, a receiver, a transmitter, a speaker, a display, an image capturing sensor, e.g., those used in a digital still camera or digital video camera, a clock, an output port, a user input device (such as a keyboard, a keypad, a mouse, and the like, or a microphone for capturing speech commands)). In one aspect, the contextual availability routing code may be implemented as a software application such as a mobile application, a desktop application, a web application, or the like.

In one aspect, the set of contextual availability routing code 408 is loaded from a storage medium associated with the data storage device 410, e.g., a magnetic or optical drive, diskette, or non-volatile memory, and operated by the processor 402 in the memory 406 of the system 304. As such, the set of contextual availability routing code 408 (including associated data structures) of the present disclosure may be stored on a computer readable medium, e.g., RAM memory, magnetic or optical drive or diskette or the like.

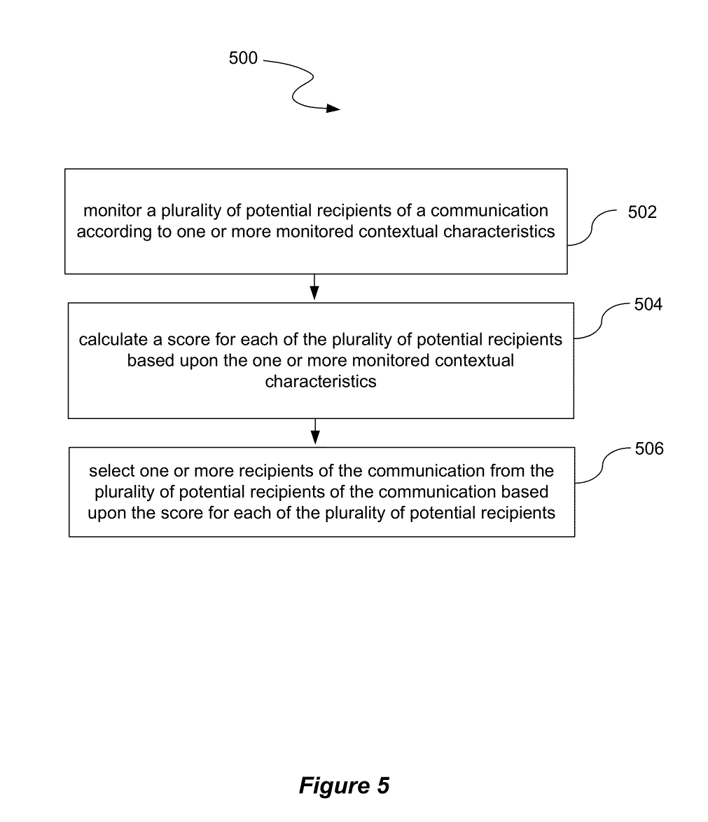

FIG. 5 illustrates a process 500 that is utilized to provide contextual routing availability. At a process block 502, the process 500 monitors a plurality of potential recipients of a communication according to one or more monitored contextual characteristics. Further, at a process block 504, the process 500 calculates a score for each of the plurality of potential recipients based upon the one or more monitored contextual characteristics. In addition, at a process block 506, the process 500 selects one or more recipients of the communication from the plurality of potential recipients of the communication based upon the score for each of the plurality of potential recipients.

The processes described herein may be implemented in a general, multi-purpose or single purpose processor. Such a processor will execute instructions, either at the assembly, compiled or machine-level, to perform the processes. Those instructions can be written by one of ordinary skill in the art following the description of the figures corresponding to the processes and stored or transmitted on a computer readable medium. The instructions may also be created using source code or a computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized data through wireline or wireless transmissions locally or remotely through a network. A computer is herein intended to include any device that has a general, multi-purpose or single purpose processor as described above. For example, a computer may be a personal computer (“PC”), laptop, smartphone, tablet device, set top box, or the like.

It is understood that the apparatuses, systems, computer program products, and processes described herein may also be applied in other types of apparatuses, systems, computer program products, and processes. Those skilled in the art will appreciate that the various adaptations and modifications of the aspects of the apparatuses, systems, computer program products, and processes described herein may be configured without departing from the scope and spirit of the present apparatuses, systems, computer program products, and processes. Therefore, it is to be understood that, within the scope of the appended claims, the present apparatuses, systems, computer program products, and processes may be practiced other than as specifically described herein.

We claim:

1. A computer program product comprising a computer readable storage device having a computer readable program stored thereon, wherein the computer readable program while executing on a computer causes the computer to:
monitor a plurality of potential recipients of a communication according to one or more monitored contextual characteristics;
calculate a score for each of the plurality of potential recipients based upon the one or more monitored contextual characteristics; and
select one or more recipients of the communication from the plurality of potential recipients of the communication based upon the score for each of the plurality of potential recipients.

2. The computer program product of claim 1, wherein the computer is further caused to determine a mode of the communication based upon the one or more monitored contextual characteristics.

3. The computer program product of claim 1, wherein the one or more monitored contextual characteristics is selected from the group consisting of recipient availability for the communication, recipient willingness to participate in the communication, recipient location data, available modes of communication, past recipient behavior, and future recipient plans.

4. The computer program product of claim 1, wherein the computer is further caused to ensure that the communication is received by the one or more recipients that are selected.

5. The computer program product of claim 1, wherein the computer is further caused to rank the plurality of potential recipients of the communication according to a contextual availability ranking based upon the score for each of the plurality of potential recipients.

6. The computer program product of claim 5, wherein the contextual availability ranking dynamically changes based upon one or more changes to the one or more monitored contextual characteristics.

7. The computer program product of claim 1, wherein the computer is further caused to rank the plurality of potential recipients of the communication according to a contextual availability ranking based upon the score for each of the plurality of potential recipients.

8. A method comprising:
monitoring a plurality of potential recipients of a communication according to one or more monitored contextual characteristics;
calculating, with a processor, a score for each of the plurality of potential recipients based upon the one or more monitored contextual characteristics; and
selecting one or more recipients of the communication from the plurality of potential recipients of the communication based upon the score for each of the plurality of potential recipients.

9. The method of claim 8, further comprising determining a mode of the communication based upon the one or more monitored contextual characteristics.

10. The method of claim 8, wherein the one or more monitored contextual characteristics is selected from the group consisting of recipient availability for the communication, recipient willingness to participate in the communication, recipient location data, available modes of communication, past recipient behavior, and future recipient plans.

11. The method of claim 8, further comprising ensuring that the communication is received by the one or more recipients that are selected.

12. The method of claim 8, further comprising ranking the plurality of potential recipients of the communication according to a contextual availability ranking based upon the score for each of the plurality of potential recipients.

13. The method of claim 12, wherein the contextual availability ranking dynamically changes based upon one or more changes to the one or more monitored contextual characteristics.

14. The method of claim 8, further comprising ranking the plurality of potential recipients of the communication according to a contextual availability ranking based upon the score for each of the plurality of potential recipients.

15. A system comprising:
a processor configured to monitor a plurality of potential recipients of a communication according to one or more monitored contextual characteristics, calculate a score for each of the plurality of potential recipients based upon the one or more monitored contextual characteristics, and select one or more recipients of the communication from the plurality of potential recipients of the communication based upon the score for each of the plurality of potential recipients.

16. The system of claim 15, wherein the processor is further configured to determine a mode of the communication based upon the one or more monitored contextual characteristics.

17. The system of claim 15, wherein the one or more monitored contextual characteristics is selected from the group consisting of recipient availability for the communication, recipient willingness to participate in the communication, recipient location data, available modes of communication, past recipient behavior, and future recipient plans.

18. The system of claim 15, wherein the processor is further configured to ensure that the communication is received by the one or more recipients that are selected.

19. The system of claim 15, wherein the processor is further configured to rank the plurality of potential recipients of the communication according to a contextual availability ranking based upon the score for each of the plurality of potential recipients.

20. The system of claim 19, wherein the contextual availability ranking dynamically changes based upon one or more changes to the one or more monitored contextual characteristics.

21. The system of claim 15, wherein the processor is further configured to rank the plurality of potential recipients of the communication according to a contextual availability ranking based upon the score for each of the plurality of potential recipients.
